(19) United States
(12) Patent Application Publication
(10) Pub. No.: US 2011/0119252 A1
(43) Pub. Date: May 19, 2011

(54) Pricing Access to Data Using Contribution Analysis

(75) Inventors: Moe Khosravy, Bellevue, WA (US); Lev Novik, Bellevue, WA (US)

(73) Assignee: MICROSOFT CORPORATION, Redmond, WA (US)

(21) Appl. No.: 12/620,246

(22) Filed: Nov. 17, 2009

(51) Int. Cl. G06F 17/30

(52) U.S. Cl. 707/720; 707/E17.131

(57) ABSTRACT

Techniques are described herein for pricing access to data using contribution analysis. A user may issue a query to a store that stores data. The store may analyze a subset of the data to determine a result that is to be provided to the user in response to the query. The subset is referred to as contribution data. A data access price calculator performs a contribution analysis to determine a price to be charged to the user to access the result. The contribution analysis takes into consideration a number of rows and/or columns of data in the contribution data, a number of rows and/or columns of data in the result, functions used during the store's analysis of the contribution data, or a combination thereof. The data access price calculator may derive such information from an indicator that is received from the store and/or to some extent from the result itself.

### BACKGROUND

A data consumption system hosts data of providers in a networked environment to make the data accessible to users of the system. The system includes a store in which the data is stored. A store is a storage system (e.g., a database) that is capable of storing data. A user may submit a query to the store via the network, for example. The store may parse the query to determine which data is to be analyzed for generating a response to the user's query. The data that is analyzed may be referred to as contribution data. Upon analyzing the contribution data in accordance with the user's query, the store generates a result that includes a subset of the contribution data. The store then provides the result to the user via the network, for example.

A user may be charged a fee for accessing the data that is stored in the store. However, conventional pricing models for charging such a fee have their limitations. One conventional pricing model is a subscription pricing model. According to the subscription pricing model, the user is charged a subscription fee, which authorizes the user to access the data for a designated period of time (e.g., a month, a year, etc.). The subscription often may be renewed for successive periods by paying additional periodic subscription fees. However, the subscription pricing model typically does not differentiate between users who access a substantial amount of data and users who access a lesser amount of data. For instance, a user is often granted unlimited access to the data under the subscription pricing model.

Another conventional pricing model is the per-request pricing model. According to the per-request pricing model, the user is charged a designated fee for each query that the user submits to the store. However, the per-request pricing model typically does not differentiate between the various types of queries that the user may submit or the types of data that are accessed in response to the queries.

### SUMMARY

Various approaches are described herein for, among other things, pricing access to data using contribution analysis. For instance, a user may issue a query to a store that stores data. The data may be represented in any suitable format. For example, the data may be represented as objects having properties. In accordance with this example, the objects may be elements in an extensible markup language (XML) document, rows in a relational database, columns in a column store, etc. The store may analyze a subset of the data to determine a result that is to be provided to the user in response to the query. The subset of the data that is analyzed is referred to as contribution data.

A data access price calculator performs a contribution analysis to determine a price that is to be charged to the user to access the result. The contribution analysis takes into consideration a number of rows and/or columns of the data that are included in the contribution data, a number of rows and/or columns of the data that are included in the result, functions that are used during the store's analysis of the contribution data, or any combination thereof. For example, the data access price calculator may derive such information from an indicator that is received from the store. In another example, the data access price calculator may derive the number of rows and/or columns of the data that are included in the result from the result itself.

An example method is described in which a query is executed against a store that stores data among tables. Each table includes respective rows and columns of the data. A result is received based on the query. The result includes a subset of the data. A number of rows of the data in the subset is determined. A price to charge a user who issues the query to access the result is determined based on the determined number of the rows of the data in the subset.

Another example method is described in which a non-inline query plan regarding a query is requested from a store. A query plan is a set of operations that is to be performed by a store to generate a result in response to execution of a query against the store. A non-inline query plan is a query plan in which not all functions are inlined. A function is a sub-query that is referenced in a query. A function is said to be inlined if its definition is incorporated (i.e., inlined) into the query by the store; whereas, a function is said to be non-inlined if it is called by the store when the query is executed against the store. Thus, a function that is inlined is included in a query plan by incorporating the definition of the function into the query plan; whereas, a function that is non-inlined is included in a query plan by listing a function call to that function. Upon requesting the non-inline query plan, a determination is made that the query plan includes a function to be executed with respect to the query. A function price of the function is determined. A price to charge a user who issues the query to access a result that corresponds to the query is determined based on the function price.

An example system is described that includes a query execution module, a result row determination module, and an access price determination module. The query execution module is configured to execute a query against a store that stores data among tables. Each table includes respective rows and columns of the data. The result row determination module is configured to determine a number of rows of the data in a result that is received in response to execution of the query. The result includes a subset of the data. The access price determination module is configured to determine a price to charge a user who issues the query to access the result based on the determined number of the rows of the data in the result.

Another example system is described that includes a query plan request module, a function determination module, a function price determination module, and an access price determination module. The query plan request module is configured to request a non-inline query plan regarding a query from a store. The function determination module is configured to determine that the query plan includes a function to be executed with respect to the query. The function price determination module is configured to determine a function price of the function. The access price determination module is configured to determine a price to charge a user who issues the query to access a result that corresponds to the query based on the function price.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Moreover, it is noted that the invention is not limited to the specific embodiments described in the Detailed Description and/or other sections of this document. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the present invention and, together with the description, further serve to explain the principles involved and to enable a person skilled in the relevant art(s) to make and use the disclosed technologies.

FIG. 1 is a block diagram of an example data consumption system in accordance with an embodiment.

FIGS. 2, 4, 6, and 8 depict flowcharts of methods for pricing access to data using contribution analysis in accordance with embodiments.

FIGS. 3, 5, 7, and 9 are block diagrams of example implementations of a data access price calculator shown in FIG. 1 in accordance with embodiments.

FIG. 10 depicts an example computer in which embodiments may be implemented.

The features and advantages of the disclosed technologies will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the relevant art(s) to implement such feature, structure, or characteristic in connection with other embodiments whether or not explicitly described.

### II. Pricing Access to Data Using Contribution Analysis

Example embodiments are capable of pricing access to data using contribution analysis. For instance, a user may issue a query to a store that stores data. The data may be represented in any suitable format. For example, the data may be represented as objects having properties. In accordance with this example, the objects may be elements in an extensible markup language (XML) document, rows in a relational database, columns in a column store, etc. The store may analyze a subset of the data to determine a result that is to be provided to the user in response to the query. The subset of the data that is analyzed is referred to as contribution data. A data access price calculator performs a contribution analysis to determine a price that is to be charged to the user to access the result. The contribution analysis takes into consideration a number of rows and/or columns of the data that are included in the contribution data, a number of rows and/or columns of the data that are included in the result, functions that are used during the store's analysis of the contribution data, or any combination thereof. For example, the data access price calculator may derive such information from an indicator that is received from the store. In another example, the data access price calculator may derive the number of rows and/or columns of the data that are included in the result from the result itself.

Techniques described herein for pricing access to data using contribution analysis are applicable to stored procedures, though the scope of the example embodiments is not limited in this respect. A stored procedure (a.k.a. proc, sproc, StoPro, SP, etc.) is a precompiled query that is capable of being executed multiple times without the need to send the query to a store each time and without the need to re-compile the query each time. For instance, using a stored procedure (as opposed to other types of queries) may reduce network traffic and/or processor load in a data consumption system. A stored procedure is one example type of query. It will be recognized that the techniques described herein are applicable to any suitable type of query.

The techniques described herein have a variety of benefits as compared to conventional techniques for pricing access to data. For example, data may be sold at a more granular level (e.g., on a per-row, per-column, or per-cell basis) using the techniques described herein. A cell corresponds to a single row and a single column of the data. The number of columns and/or rows in the result and/or the type of data therein may be taken into account in the pricing. Users who access a relatively greater amount of data may be charged more than users who access a relatively lesser amount of the data. For instance, a user who submits a query for which a substantial amount of contribution data is analyzed may be charged more than a user who submits a query for which a lesser amount of contribution data is analyzed. Pricing may be based on the type of query, the type of data that is analyzed in response to the query, etc. Prices may be established for designated functions, which define operations that may be performed during analysis of the contribution data. The prices for the designated functions may be independent of the amount of the contribution data analyzed with respect to the functions.

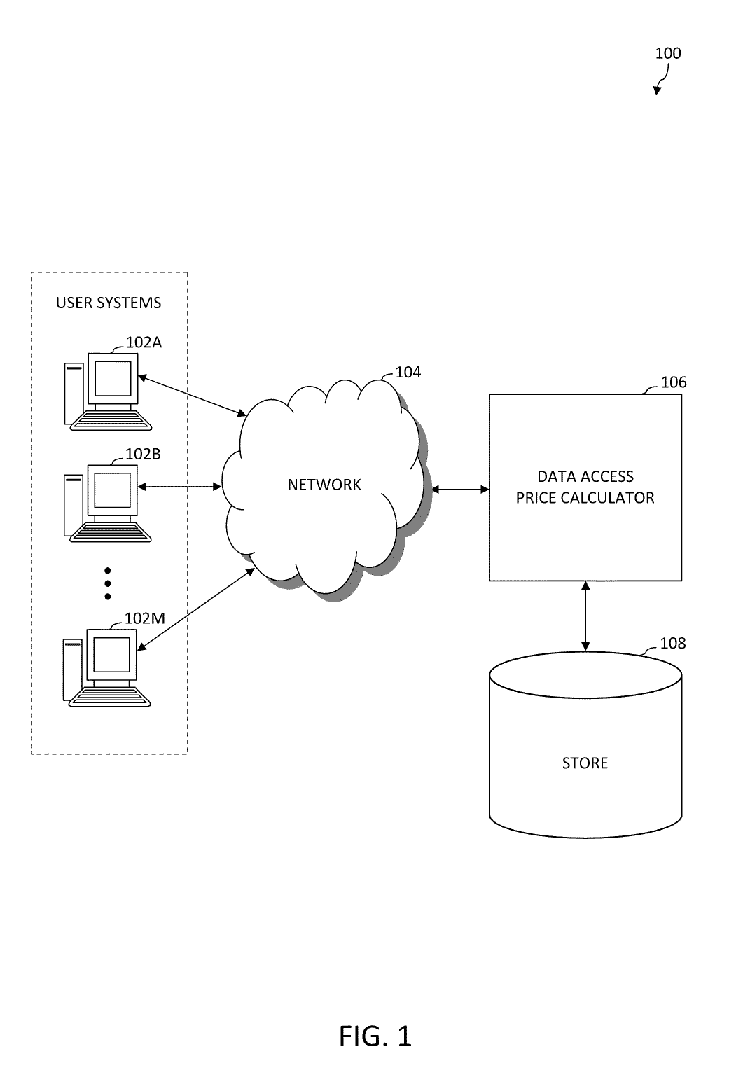

FIG. 1 is a block diagram of an example data consumption system 100 in accordance with an embodiment. Generally speaking, data consumption system 100 operates to host data of providers to make the data accessible to users of the system. According to example embodiments, data consumption system 100 operates to determine prices to charge the users to access the data using contribution analysis. Further detail regarding techniques for pricing access to data using contribution analysis is provided in the following discussion.

As shown in FIG. 1, data consumption system 100 includes a plurality of user systems 102A-102M, a network 104, a data access price calculator 106, and a store 108. Communication among user systems 102A-102M and data access price calculator 106 is carried out over network 104 using well-known network communication protocols. Network 104 may be a wide-area network (e.g., the Internet), a local area network (LAN), another type of network, or a combination thereof. Communication between data access price calculator 106 and store 108 is carried out using well-known query languages, such as Structured Query Language (SQL), Java Persistence Query Language (JPQL), etc.

User systems 102A-102M are processing systems that are capable of providing queries to data access price calculator 106 for requesting data stored on (or otherwise accessible to) store 108. An example of a processing system is a system that includes at least one processor that is capable of manipulating data in accordance with a set of instructions. For instance, a processing system may be a computer, a personal digital assistant, etc. For example, a user may initiate a query for data using a client (e.g., a Web browser, Web crawler, or other type of client) deployed on a user system 102 that is owned by or otherwise accessible to the user.

Although user systems 102A-102M are depicted as desktop computers in FIG. 1, persons skilled in the relevant art(s) will appreciate that user systems 102A-102M may include any client-enabled system or device, including but not limited to a laptop computer, a personal digital assistant, a cellular telephone, or the like.

Data access price calculator 106 is a processing system that is capable of determining a price to charge a user who issues a query to access data that is stored on (or otherwise accessible to) store 108. Upon receipt of the user's query, data access price calculator 106 executes the query against store 108. Data access price calculator 106 receives a result that is based on the query from store 108. Data access price calculator 106 may also receive a contribution analysis indicator from store 108. A contribution analysis indicator includes information to facilitate a contribution analysis to be performed by data access price calculator 106. For instance, the contribution analysis indicator may specify a number of rows and/or columns of data that are included in contribution data regarding the user's query, a number of rows and/or columns of the data that are included in the result, functions that are used during the analysis of the contribution data, etc. Data access price calculator 106 analyzes the result and/or the contribution analysis indicator to determine the price to charge the user to access the result. Data access price calculator 106 may forward the result to the user system 102 from which the query was initiated.

Store 108 is a storage device or system that stores data among tables. Each table includes respective rows and columns of the data. Store 108 may include processing functionality, though the scope of the example embodiments is not limited in this respect. For example, store 108 may determine which data that is stored on (or otherwise accessible to) store 108 is to be analyzed based on the query that is executed by data access price calculator 106. In accordance with this example, store 108 may analyze that data to determine a result based on the query. The data that is analyzed is referred to as contribution data. Store 108 may generate a contribution analysis indicator, though the scope of the example embodiments is not limited in this respect. A contribution analysis indicator specifies a number of rows and/or columns of data that are included in the contribution data, a number of rows and/or columns of the data that are included in the result, functions that are used during the analysis of the contribution data, or any combination thereof. Store 108 provides the result and the contribution analysis indicator (if applicable) to data access price calculator 106 for further processing with respect to a contribution analysis.

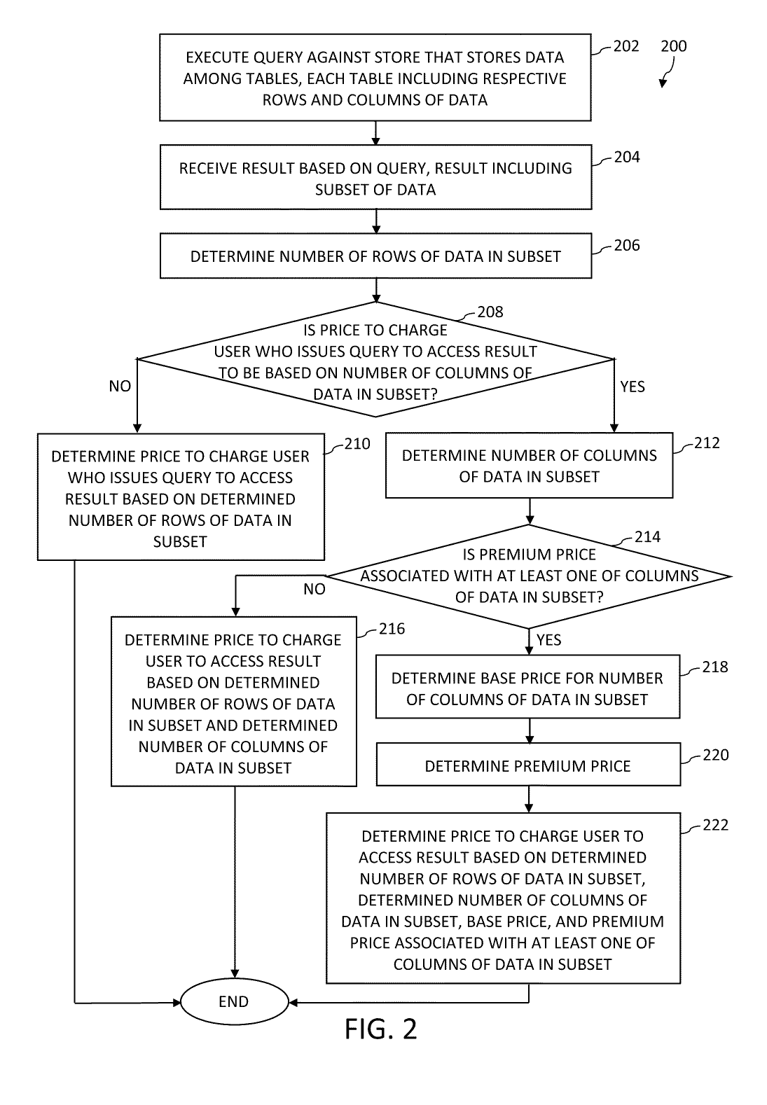

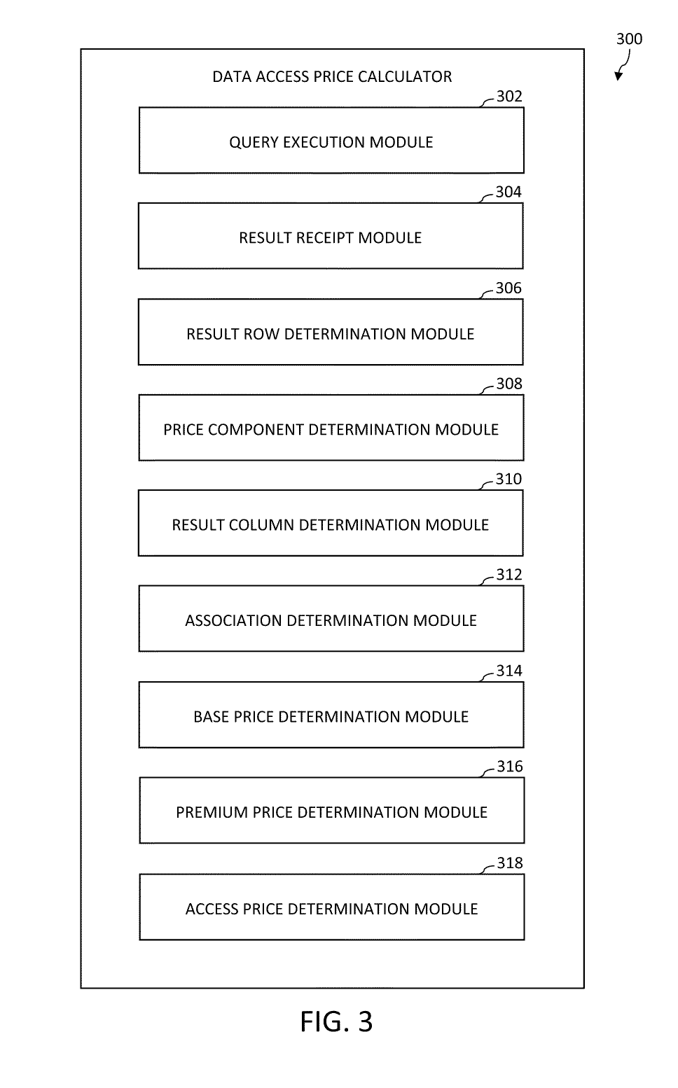

FIG. 2 depicts a flowchart 200 of a method for pricing access to data using contribution analysis in accordance with an embodiment. Flowchart 200 may be performed by data access price calculator 106 of data consumption system 100 shown in FIG. 1, for example. For illustrative purposes, flowchart 200 is described with respect to a data access price calculator 300 shown in FIG. 3, which is an example of a data access price calculator 106, according to an embodiment. As shown in FIG. 3, data access price calculator 300 includes a query execution module 302, a result receipt module 304, a result row determination module 306, a price component determination module 308, a result column determination module 310, an association determination module 312, a base price determination module 314, a premium price determination module 316, and an access price determination module 318. Further structural and operational embodiments will be apparent to persons skilled in the relevant art(s) based on the discussion regarding flowchart 200. Flowchart 200 is described as follows.

As shown in FIG. 2, the method of flowchart 200 begins at step 202. In step 202, a query is executed against a store that stores data among tables. Each table includes respective rows and columns of the data. The data stored by the store may be directed to a variety of topics. For instance, a first table may include data regarding houses that are for sale in a designated region, a second table may include data regarding a designated genre of movies, a third table may include data regarding recipes, and so on. For illustrative purposes, the steps of flowchart 200 will be discussed with respect to an example query that requests a list of all of the grocery stores that are located in Los Angeles. This example will be referred to as “the grocery store example” in the following discussion. The query that is executed in the grocery store example is merely one example query, and it will be recognized that any suitable query may be executed against the store. In an example embodiment, query execution module 302 executes the query.

At step 204, a result based on the query is received. The result includes a subset of the data. In accordance with the grocery store example, the result may include the requested list of all of the grocery stores that are located in Los Angeles. It will be recognized that the list of grocery stores in this result is a subset of the data that is stored by the store. For instance, the store may store other data, such as data regarding houses that are for sale, data regarding movies, data regarding recipes, etc. In an example implementation, result receipt module 304 receives the result.

At step 206, a number of rows of the data in the subset is determined. In accordance with the grocery store example, each row may represent a respective grocery store in the list of grocery stores that is included in the result. In an example implementation, result row determination module 306 determines the number of rows of the data in the subset.

At step 208, a determination is made whether a price to charge a user who issues the query to access the result is to be based on a number of columns of the data in the subset. In accordance with the grocery store example, each column may represent a respective property of the grocery stores. For instance, the properties may include hours of operation, telephone numbers, addresses, customer ratings, etc. The price to charge the user may depend on the number of the properties that the result includes. In an example implementation, price component determination module 308 determines whether the price to charge the user to access the result is to be based on the number of columns of the data in the subset. If the price is to be based on the number of columns of the data in the subset, flow continues to step 212. Otherwise, flow continues to step 210.

At step 210, the price to charge the user who issues the query to access the result is determined based on the determined number of rows of the data in the subset. In accordance with the grocery store example, the price is based on the number of grocery stores that are included in the list of grocery stores in the result. In an example implementation, access price determination module 318 determines the price based on the determined number of rows of the data in the subset. Upon completion of step 210, flowchart 200 ends.

At step 212, the number of columns of the data in the subset is determined. In accordance with the grocery store example, the number of properties of the grocery stores that are included in the result is determined. In an example implementation, result column determination module 310 determines the number of columns of the data in the subset.

At step 214, a determination is made whether a premium price is associated with at least one of the columns of the data in the subset. In accordance with the grocery store example, assume for purposes of illustration that a premium price may be charged for the customer ratings of the grocery stores that are included in the result. In an example implementation, association determination module 312 determines whether a premium price is associated with at least one of the columns of the data in the subset. If a premium price is associated with at least one of the columns of the data in the subset, flow continues to step 218. Otherwise, flow continues to step 216.

At step 216, the price to charge the user to access the result is determined based on the determined number of rows of the data in the subset and the determined number of columns of the data in the subset. In accordance with the grocery store example, the price is based on the number of grocery stores and the number of properties of the grocery stores that are included in the result. In an example implementation, access price determination module 318 determines the price based on the determined number of rows of the data in the subset and the determined number of columns of the data in the subset. Upon completion of step 216, flowchart 200 ends.

At step 218, a base price for the number of columns of the data in the subset is determined. For instance, the base price may be a fixed price that is independent of the number of columns of the data in the subset. Alternatively, the base price may be proportional to the number of columns of the data in the subset. In accordance with the grocery store example, the base price is determined for the number of properties of the grocery stores that are included in the result. In an example implementation, base price determination module 314 determines the base price.

At step 220, the premium price is determined. In an example implementation, premium price determination module 316 determines the premium price.

At step 222, the price to charge the user to access the result is determined based on the determined number of rows of the data in the subset, the determined number of columns of the data in the subset, the base price, and the premium price that is associated with the at least one of the columns of the data in the subset. In accordance with the grocery store example, the price is based on the number of grocery stores that are included in the result, the number of properties of the grocery stores that are included in the result, the base price, and the premium price. In an example implementation, access price determination module 318 determines the price to charge the user based on the determined number of rows of the data in the subset, the determined number of columns of the data in the subset, the base price, and the premium price. Upon completion of step 222, flowchart 200 ends.

In accordance with an example embodiment, rows that are included in some tables of the store may be associated with a higher price than rows that are included in other tables of the store. For instance, rows in a first table may be associated with a first price; rows in a second table may be associated with a second price, and so on. Such differences in price between the rows may be taken into consideration when the price to charge the user is determined.

In some example embodiments, one or more steps 202, 204, 206, 208, 210, 212, 214, 216, 218, 220, and/or 222 of flowchart 200 may not be performed. Moreover, steps in addition to or in lieu of steps 202, 204, 206, 208, 210, 212, 214, 216, 218, 220, and/or 222 may be performed.

It will be recognized that data access price calculator 300 may not include one or more of query execution module 302, result receipt module 304, result row determination module 306, price component determination module 308, result column determination module 310, association determination module 312, base price determination module 314, premium price determination module 316, and/or access price determination module 318. Furthermore, data access price calculator 300 may include modules in addition to or in lieu of query execution module 302, result receipt module 304, result row determination module 306, price component determination module 308, result column determination module 310, association determination module 312, base price determination module 314, premium price determination module 316, and/or access price determination module 318.

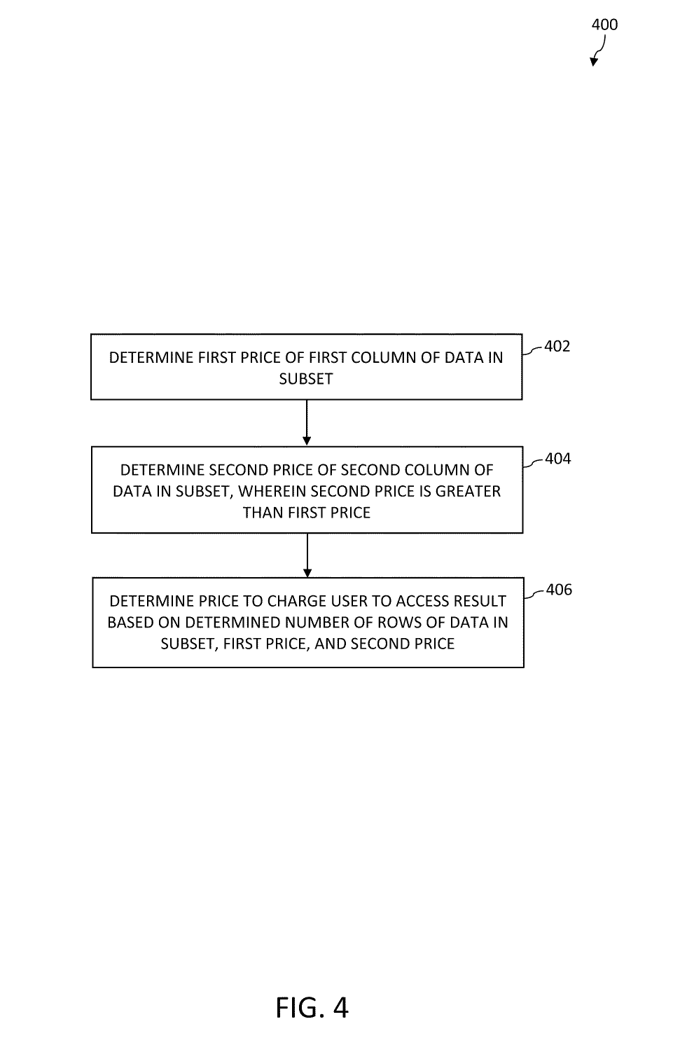

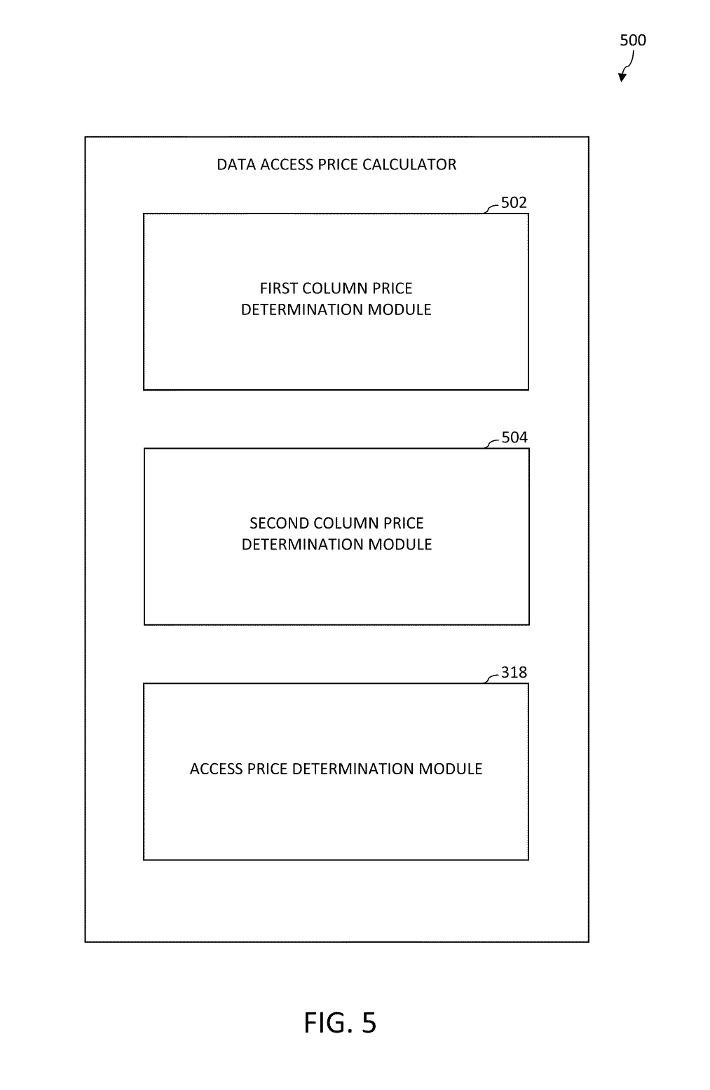

In accordance with an example embodiment, steps 208, 210, 212, 214, 216, 218, 220, and 222 of flowchart 200 may be replaced with the steps shown in flowchart 400 of FIG. 4. Flowchart 400 is described with respect to a data access price calculator 500 shown in FIG. 5, which is an example of a data access price calculator 106, according to an embodiment. As shown in FIG. 5, data access price calculator 500 includes a first column price determination module 502, a second column price determination module 504, and an access price determination module 318. Further structural and operational embodiments will be apparent to persons skilled in the relevant art(s) based on the discussion regarding flowchart 400. Flowchart 400 is described as follows.

As shown in FIG. 4, the method of flowchart 400 begins at step 402. In step 402, a first price of a first column of the data in the subset is determined. In an example implementation, first column price determination module 502 determines the first price of the first column.

At step 404, a second price of a second column of the data in the subset is determined. The second price is greater than the first price. As discussed above in the grocery store example with reference to FIG. 2, the price of customer ratings of grocery stores may be priced higher than the telephone numbers of the grocery stores. Accordingly, the first price of the first column of the data may correspond to the price of the telephone numbers of the grocery stores, and the second price of the second column of the data may correspond to the price of the customer ratings of the grocery stores. In an example implementation, second column price determination module 504 determines the second price of the second column.

At step 406, the price to charge the user to access the result is determined based on the determined number of rows of the data in the subset, the first price, and the second price. In accordance with the grocery store example, the price is based on the number of grocery stores that are included in the list of grocery stores in the result, the price of the telephone numbers of the grocery stores, and the price of the customer ratings of the grocery stores. In an example implementation, access price determination module 308 determines the price to charge the user based on the determined number of rows of the data in the subset, the first price, and the second price.

The methods that are illustrated in flowcharts 200 and 400 of respective FIGS. 2 and 4 take into consideration the amount of data that is included in a result that is based on a query. In accordance with these methods, a user may be charged more to access a result that includes a substantial amount of data than to access a result that includes a lesser amount of data. However, results regarding some queries include a relatively insubstantial amount (e.g., one row) of data, though execution of the queries may have involved analyzing a substantial amount of contribution data. In such instances, it may be desirable to use a pricing model that takes into consideration the amount of the contribution data to determine the price to charge users to access the results.

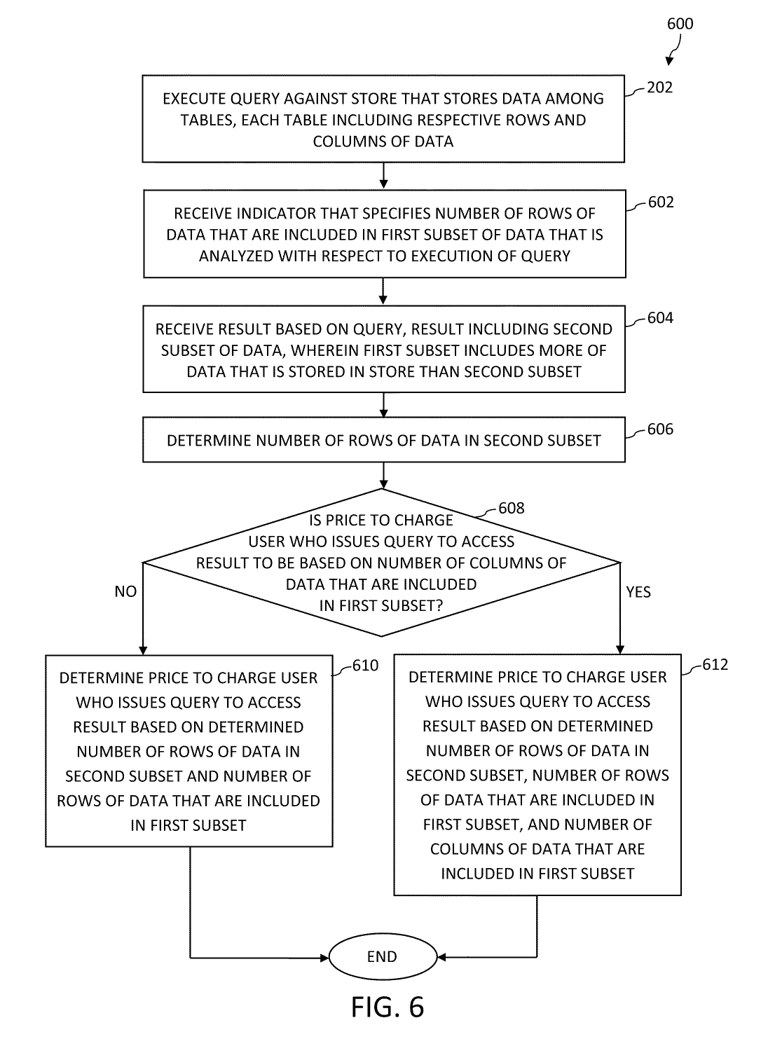

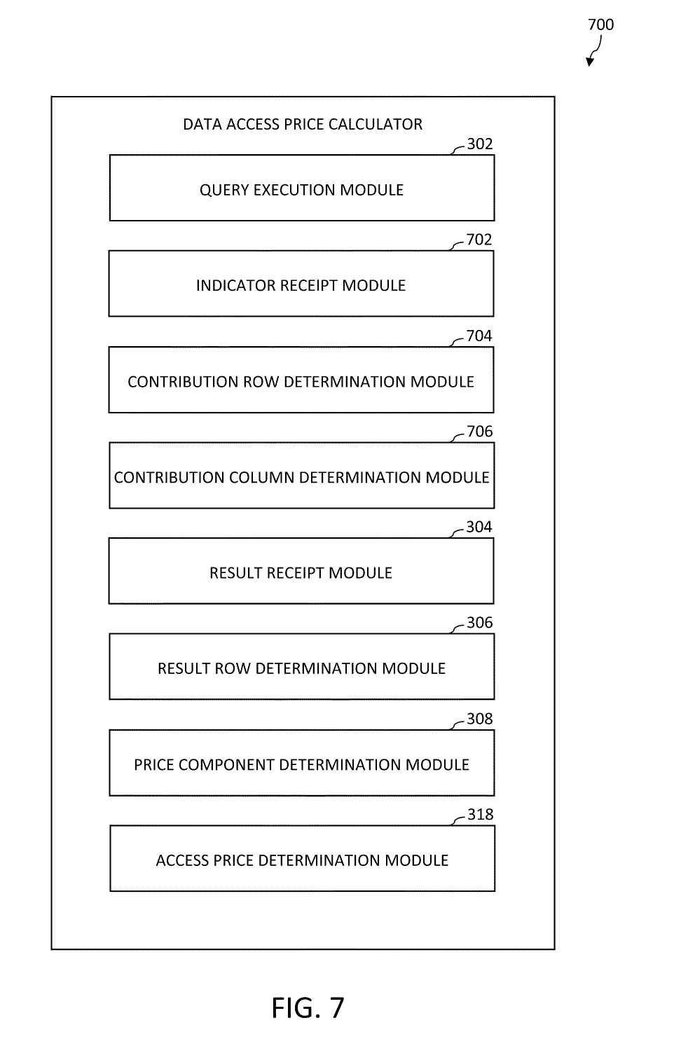

FIG. 6 depicts a flowchart 600 of a method for pricing access to data that takes into consideration the amount of contribution data that is analyzed with respect to a query in accordance with an embodiment. For illustrative purposes, flowchart 600 is described with respect to a data access price calculator 700 shown in FIG. 7, which is an example of a data access price calculator 106, according to an embodiment. As shown in FIG. 7, data access price calculator 700 includes a query execution module 302, an indicator receipt module 702, a contribution row determination module 704, a contribution column determination module 706, a result receipt module 304, a result row determination module 306, a price component determination module 308, and an access price determination module 318. Further structural and operational embodiments will be apparent to persons skilled in the relevant art(s) based on the discussion regarding flowchart 600. Flowchart 600 is described as follows.

As shown in FIG. 6, the method of flowchart 600 begins at step 202. In step 202, a query is executed against a store that stores data among tables. Each table includes respective rows and columns of the data. For illustrative purposes, the steps of flowchart 600 will be discussed with respect to an example query that requests the highest rated Chinese restaurant in Los Angeles. This example will be referred to as “the restaurant example” in the following discussion. The query that is executed in the restaurant example is merely one example query, and it will be recognized that any suitable query may be executed against the store. In an example embodiment, query execution module 302 executes the query.

At step 602, an indicator is received that specifies a number of rows of the data that are included in a first subset of the data that is analyzed with respect to execution of the query. In accordance with the restaurant example, the first subset of the data may include a list of all of the Chinese restaurants in Los Angeles. For instance, each row of the data that are included in the first subset of the data may represent a respective Chinese restaurant. The list of all of the Chinese restaurants in Los Angeles is referred to as the contribution data in this example. In an example implementation, indicator receipt module 702 receives the indicator.

In accordance with an example embodiment, contribution row determination module 704 determines the number of rows of the data that are included in the first subset based on the indicator. According to another example embodiment, the indicator further specifies a number of columns of the data that are included in the first subset of the data. In accordance with this embodiment, contribution column determination module 706 may determine the number of columns of the data that are included in the first subset based on the indicator.

In accordance with another example embodiment, the indicator includes a query plan that is received from the store. A query plan is a set of operations that is to be performed by a store to generate a result in response to execution of a query against the store. For instance, the query plan may specify that a first number of rows in a first table, a second number of rows in a second table, etc. are to be analyzed by the store with respect to execution of the query. In accordance with this embodiment, the number of rows of the data that are included in the first subset is the sum of the first number, the second number, etc.

At step 604, a result based on the query is received. The result includes a second subset of the data. The first subset includes more of the data that is stored in the store than the second subset. For instance, the second subset of the data may be a subset of the first subset of the data. In accordance with the restaurant example, the result includes the highest rated Chinese restaurant in Los Angeles. It will be recognized that the highest rated Chinese restaurant in Los Angeles is a subset of the contribution data (i.e., the list of all of the Chinese restaurants in Los Angeles in this example). In an example implementation, result receipt module 304 receives the result.

At step 606, a number of rows of the data in the second subset is determined. In accordance with the restaurant example, a determination is made that the result includes a single row of data that represents the highest rated Chinese restaurant in Los Angeles. In an example implementation, result row determination module 306 determines the number of rows of the data in the second subset.

At step 608, a determination is made whether a price to charge a user who issues the query to access the result is to be based on a number of columns of the data that are included in the first subset. In accordance with the restaurant example, each column in the contribution data may represent a respective property of the Chinese restaurants. For instance, the properties may include hours of operation, telephone numbers, addresses, customer ratings, etc. The price to charge the user may depend on the number of the properties that the result includes. In an example implementation, price component determination module 308 determines whether the price to charge the user to access the result is to be based on the number of columns of the data that are included in the first subset. If the price is to be based on the number of columns of the data that are included in the first subset, flow continues to step 612. Otherwise, flow continues to step 610.

At step 610, the price to charge the user who issues the query to access the result is determined based on the determined number of rows of the data in the second subset and the number of rows of the data that are included in the first subset. In accordance with the restaurant example, the price is based on the number of Chinese restaurants that are included in the result (i.e., one in this example) and the number of Chinese restaurants that are included in the contribution data. In an example implementation, access price determination module 318 determines the price based on the determined number of rows of the data in the second subset and the number of rows of the data that are included in the first subset. Upon completion of step 610, flowchart 600 ends.

At step 612, the price to charge the user who issues the query to access the result is determined based on the determined number of rows of the data in the second subset, the number of rows of the data that are included in the first subset, and the number of columns of the data that are included in the first subset. In accordance with the restaurant example, the price is based on the number of Chinese restaurants that are included in the result (i.e., one in this example), the number of Chinese restaurants that are included in the contribution data, and the number of properties of the Chinese restaurants that are included in the contribution data. In an example implementation, access price determination module 318 determines the price based on the determined number of rows of the data in the second subset, the number of rows of the data that are included in the first subset, and the number of columns of the data that are included in the first subset. Upon completion of step 612, flowchart 600 ends.

In some example embodiments, one or more steps 602, 604, 606, 608, 610, and/or 612 of flowchart 600 may not be performed. Moreover, steps in addition to or in lieu of steps 602, 604, 606, 608, 610, and/or 612 may be performed.

It will be recognized that data access price calculator 700 may not include one or more of query execution module 302, indicator receipt module 702, contribution row determination module 704, contribution column determination module 706, result receipt module 304, result row determination module 306, price component determination module 308, and/or access price determination module 318. Furthermore, data access price calculator 700 may include modules in addition to or in lieu of query execution module 302, indicator receipt module 702, contribution row determination module 704, contribution column determination module 706, result receipt module 304, result row determination module 306, price component determination module 308, and/or access price determination module 318.

The method that is illustrated in flowchart 600 of FIG. 6 takes into consideration the amount of data that is included in contribution data, which is analyzed by the store with respect to a query for purposes of determining a result. In accordance with this method, a user may be charged more to access a result for which a substantial amount of contribution data is analyzed than to access a result for which a lesser amount of contribution data is analyzed. However, it may be desirable to use a pricing model that sets a designated price for some functions that are referenced in queries that is not necessarily related to the amount of contribution data that is analyzed for those queries. For instance, function-based pricing may provide a discount with respect to pricing that takes into consideration the amount of contribution data when the amount of contribution data is substantial.

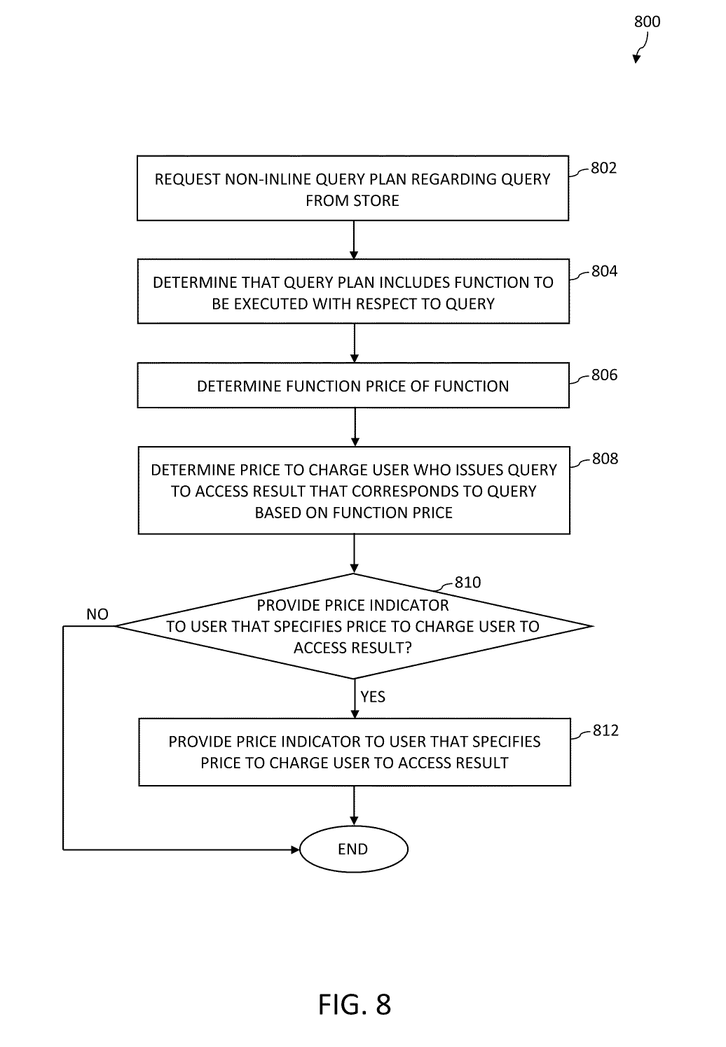

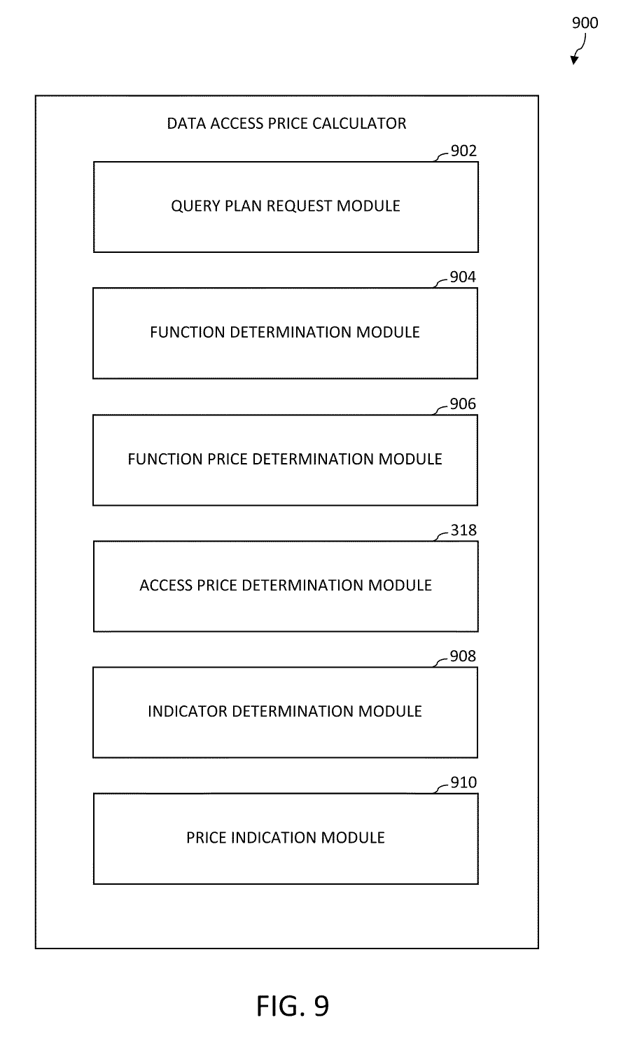

FIG. 8 depicts a flowchart 800 of a method for pricing access to data that takes into consideration a function price of a function that is to be executed with respect to a query in accordance with an embodiment. For illustrative purposes, flowchart 800 is described with respect to a data access price calculator 900 shown in FIG. 9, which is an example of a data access price calculator 106, according to an embodiment. As shown in FIG. 9, data access price calculator 900 includes a query plan request module 902, a function determination module 904, a function price determination module 906, an access price determination module 318, an indicator determination module 908, and a price indication module 910. Further structural and operational embodiments will be apparent to persons skilled in the relevant art(s) based on the discussion regarding flowchart 800. Flowchart 800 is described as follows.

As shown in FIG. 8, the method of flowchart 800 begins at step 802. In step 802, a non-inline query plan regarding a query is requested from a store. In an example implementation, query plan request module 902 requests the non-inline query plan. A query plan is a set of operations that is to be performed by a store to generate a result in response to execution of a query against the store. A non-inline query plan is a query plan in which not all functions are inlined. A function is a sub-query that is referenced in a query. A function is said to be inlined if its definition is incorporated (i.e., inlined) into the query by the store; whereas, a function is said to be non-inlined if it is called by the store when the query is executed against the store. Thus, a function that is inlined is included in a query plan by incorporating the definition of the function into the query plan; whereas, a function that is non-inlined is included in a query plan by listing a function call to that function.

For purposes of illustration, assume that a query requests all Chinese restaurants from “get points of interest within five miles”. The phrase “get points of interest within five miles” represents a function, which the store may treat as being inlined or non-inlined. If the store treats the function as being inlined, the store may modify the query to select points of interest that are Chinese restaurants, subtract the user's X-coordinate from the X-coordinates of the restaurants to provide respective X-distances, subtract the user's Y-coordinate from the Y-coordinates of the restaurant to provide respective Y-distances, square the X-distances to provide respective squared-X-distances, square the Y-distances to provide respective squared-Y-distances, add each squared-X-distance to the corresponding squared-Y-distance and take the square root of that sum to provide a respective distance, and provide the Chinese restaurants having a distance less than five miles as the result.

On the other hand, if the store treats the function as being non-inlined, the store may call the function to obtain an interim result that includes all points of interest within five miles of the user's location. The interim result may be described as a table because it includes rows and columns of data. The store may run the other aspects of the query against the interim result. In accordance with this example, the store may determine which of the points of interest that are included in the interim result are Chinese restaurants.

At step 804, a determination is made that the query plan includes a function to be executed with respect to the query. For example, a determination may be made that the query plan includes a function call to that function. In an example implementation, function determination module 904 determines that the query plan includes a function to be executed with respect to the query.

At step 806, a function price of the function is determined. In an example implementation, function price determination module 906 determines the function price of the function.

At step 808, a price to charge a user who issues the query to access a result that corresponds to the query is determined based on the function price. In an example implementation, access price determination module 318 determines the price to charge the user to access the result based on the function price.

At step 810, a determination is made whether to provide a price indicator to the user that specifies the price to charge the user to access the result. In an example implementation, indicator determination module 908 determines whether to provide the price indicator to the user. If the price indicator is to be provided to the user, flow continues to step 812. Otherwise, flowchart 800 ends.

At step 812, the price indicator that specifies the price to charge the user to access the result is provided to the user. For instance, the user may be given the option to accept the price before the user is provided access to the result. In an example implementation, price indication module 910 provides the price indicator to the user. Upon completion of step 812, flowchart 800 ends.

It should be noted that the store may process the query using functions that are inlined or functions that are non-inlined. Providing a non-inline query plan does not affect the ability of the store to process the query using functions that are inlined. In fact, processing the query using functions that are inlined may be more efficient than processing the query using functions that are non-inlined because the store may be allowed to choose the order in which operations are to be performed with respect to the query. For example, if the query requests all Chinese restaurants within five miles of the user's location, the store may determine that a result may be generated more quickly if all points of interest within five miles of the user's location are determined, followed by determining which of those points of interest are Chinese restaurants. Alternatively, the store may determine that the result may be generated more quickly if all Chinese restaurants are determined, followed by determining which of those Chinese restaurants is within five miles of the user's location. The function that is inlined gives the store the ability to make such a determination.

In some example embodiments, one or more steps 802, 804, 806, 808, 810, and/or 812 of flowchart 800 may not be performed. Moreover, steps in addition to or in lieu of steps 802, 804, 806, 808, 810, and/or 812 may be performed.

It will be recognized that data access price calculator 900 may not include one or more of query plan request module 902, function determination module 904, function price determination module 906, access price determination module 318, indicator determination module 908, and/or price indication module 910. Furthermore, data access price calculator 900 may include modules in addition to or in lieu of query plan request module 902, function determination module 904, function price determination module 906, access price determination module 318, indicator determination module 908, and/or price indication module 910.

Query execution module 302, result receipt module 304, result row determination module 306, price component determination module 308, result column determination module 310, association determination module 312, base price determination module 314, premium price determination module 316, access price determination module 318, first column price determination module 502, second column price determination module 504, indicator receipt module 702, contribution row determination module 704, contribution column determination module 706, query plan request module 902, function determination module 904, function price determination module 906, indicator determination module 908, and price indication module 910 may be implemented in hardware, software, firmware, or any combination thereof.

For example, query execution module 302, result receipt module 304, result row determination module 306, price component determination module 308, result column determination module 310, association determination module 312, base price determination module 314, premium price determination module 316, access price determination module 318, first column price determination module 502, second column price determination module 504, indicator receipt module 702, contribution row determination module 704, contribution column determination module 706, query plan request module 902, function determination module 904, function price determination module 906, indicator determination module 908, and/or price indication module 910 may be implemented as computer program code configured to be executed in one or more processors.

In another example, query execution module 302, result receipt module 304, result row determination module 306, price component determination module 308, result column determination module 310, association determination module 312, base price determination module 314, premium price determination module 316, access price determination module 318, first column price determination module 502, second column price determination module 504, indicator receipt module 702, contribution row determination module 704, contribution column determination module 706, query plan request module 902, function determination module 904, function price determination module 906, indicator determination module 908, and/or price indication module 910 may be implemented as hardware logic/electrical circuitry.

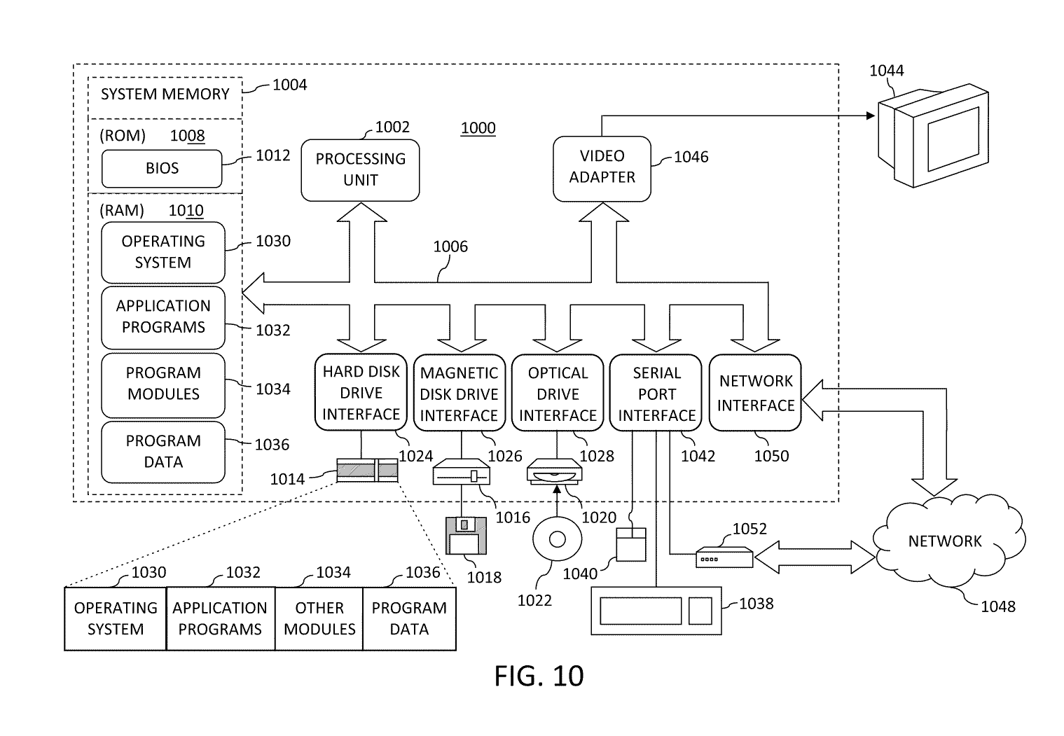

FIG. 10 depicts an example computer 1000 in which embodiments may be implemented. Any one or more of the user systems 102A-102M, data access price calculator 106, or store 108 shown in FIG. 1 (or any one or more subcomponents thereof shown in FIGS. 3, 5, 7, and 9) may be implemented using computer 1000, including one or more features of computer 1000 and/or alternative features. Computer 1000 may be a general-purpose computing device in the form of a conventional personal computer, a mobile computer, or a workstation, for example, or computer 1000 may be a special purpose computing device. The description of computer 1000 provided herein is provided for purposes of illustration, and is not intended to be limiting. Embodiments may be implemented in further types of computer systems, as would be known to persons skilled in the relevant art(s).

As shown in FIG. 10, computer 1000 includes a processing unit 1002, a system memory 1004, and a bus 1006 that couples various system components including system memory 1004 to processing unit 1002. Bus 1006 represents one or more of any of several types of bus structures, including a memory bus or memory controller, a peripheral bus, an accelerated graphics port, and a processor or local bus using any of a variety of bus architectures. System memory 1004 includes read only memory (ROM) 1008 and random access memory (RAM) 1010. A basic input/output system 1012 (BIOS) is stored in ROM 1008.

Computer 1000 also has one or more of the following drives: a hard disk drive 1014 for reading from and writing to a hard disk, a magnetic disk drive 1016 for reading from or writing to a removable magnetic disk 1018, and an optical disk drive 1020 for reading from or writing to a removable optical disk 1022 such as a CD ROM, DVD ROM, or other optical media. Hard disk drive 1014, magnetic disk drive 1016, and optical disk drive 1020 are connected to bus 1006 by a hard disk drive interface 1024, a magnetic disk drive interface 1026, and an optical drive interface 1028, respectively. The drives and their associated computer-readable storage media provide nonvolatile storage of computer-readable instructions, data structures, program modules and other data for the computer. Although a hard disk, a removable magnetic disk and a removable optical disk are described, other types of computer-readable storage media can be used to store data, such as flash memory cards, digital video disks, random access memories (RAMs), read only memories (ROM), and the like.

A number of program modules may be stored on the hard disk, magnetic disk, optical disk, ROM, or RAM. These programs include an operating system 1030, one or more application programs 1032, other program modules 1034, and program data 1036. Application programs 1032 or program modules 1034 may include, for example, computer program logic for implementing query execution module 302, result receipt module 304, result row determination module 306, price component determination module 308, result column determination module 310, association determination module 312, base price determination module 314, premium price determination module 316, access price determination module 318, first column price determination module 502, second column price determination module 504, indicator receipt module 702, contribution row determination module 704, contribution column determination module 706, query plan request module 902, function determination module 904, function price determination module 906, indicator determination module 908, price indication module 910, flowchart 200 (including any step of flowchart 200), flowchart 400 (including any step of flowchart 400), flowchart 600 (including any step of flowchart 600), and/or flowchart 800 (including any step of flowchart 800), as described herein.

A user may enter commands and information into the computer 1000 through input devices such as keyboard 1038 and pointing device 1040. Other input devices (not shown) may include a microphone, joystick, game pad, satellite dish, scanner, or the like. These and other input devices are often connected to the processing unit 1002 through a serial port interface 1042 that is coupled to bus 1006, but may be connected by other interfaces, such as a parallel port, game port, or a universal serial bus (USB).

A display device 1044 (e.g., a monitor) is also connected to bus 1006 via an interface, such as a video adapter 1046. In addition to display device 1044, computer 1000 may include other peripheral output devices (not shown) such as speakers and printers.

Computer 1000 is connected to a network 1048 (e.g., the Internet) through a network interface or adapter 1050, a modem 1052, or other means for establishing communications over the network. Modem 1052, which may be internal or external, is connected to bus 1006 via serial port interface 1042.

As used herein, the terms “computer program medium” and “computer-readable medium” are used to generally refer to media such as the hard disk associated with hard disk drive 1014, removable magnetic disk 1018, removable optical disk 1022, as well as other media such as flash memory cards, digital video disks, random access memories (RAMs), read only memories (ROM), and the like.

As noted above, computer programs and modules (including application programs 1032 and other program modules 1034) may be stored on the hard disk, magnetic disk, optical disk, ROM, or RAM. Such computer programs may also be received via network interface 1050 or serial port interface 1042. Such computer programs, when executed or loaded by an application, enable computer 1000 to implement features of embodiments discussed herein. Accordingly, such computer programs represent controllers of the computer 1000.

Example embodiments are also directed to computer program products comprising software (e.g., computer-readable instructions) stored on any computer useable medium. Such software, when executed in one or more data processing devices, causes a data processing device(s) to operate as described herein. Embodiments may employ any computer-useable or computer-readable medium, known now or in the future. Examples of computer-readable mediums include, but are not limited to storage devices such as RAM, hard drives, floppy disks, CD ROMs, DVD ROMs, zip disks, tapes, magnetic storage devices, optical storage devices, MEMS-based storage devices, nanotechnology-based storage devices, and the like.

### III. Conclusion

While various embodiments have been described above, it should be understood that they have been presented by way of example only, and not limitation. It will be apparent to persons skilled in the relevant art(s) that various changes in form and details can be made therein without departing from the spirit and scope of the invention. Thus, the breadth and scope of the present invention should not be limited by any of the above-described example embodiments, but should be defined only in accordance with the following claims and their equivalents.

What is claimed is:

1. A method of pricing access to data in a networked environment, comprising:
executing a query against a store that stores data among a plurality of tables, each table including respective rows and columns of the data;
receiving a result based on the query, the result including a subset of the data;
determining a number of rows of the data in the subset; and
determining a price to charge a user who issues the query to access the result based on the determined number of the rows of the data in the subset.

2. The method of claim 1, further comprising:
determining a number of columns of the data in the subset;
wherein determining the price to charge the user to access the result based on the determined number of the rows of the data in the subset comprises:
determining the price to charge the user to access the result based on the determined number of the rows of the data in the subset and the determined number of the columns of the data in the subset.

3. The method of claim 2, further comprising:
receiving an indicator that specifies a number of rows and a number of columns of the data that are included in a second subset of the data that is analyzed with respect to execution of the query;
wherein the second subset includes more of the data that is stored in the store than the first subset; and
wherein determining the price to charge the user to access the result based on the determined number of the rows of the data in the subset comprises:
determining the price to charge the user to access the result based on the determined number of the rows of the data in the first subset, the determined number of the columns of the data in the first subset, and the number of the rows and the number of the columns of the data that are included in the second subset.

4. The method of claim 3, further comprising:
determining a base price for the number of the columns of the data in the first subset; and
determining a premium price associated with at least one of the columns of the data in the first subset that is to be charged in addition to the base price;
wherein determining the price to charge the user to access the result based on the determined number of the rows of the data in the subset comprises:
determining the price to charge the user to access the result based on the determined number of the rows of the data in the first subset, the determined number of the columns of the data in the first subset, the number of the rows and the number of the columns of the data that are included in the second subset, the base price, and the premium price.

5. The method of claim 1, further comprising:
determining a first price of a first column of the data in the subset; and
determining a second price of a second column of the data in the subset;
wherein the second price is greater than the first price; and
wherein determining the price to charge the user to access the result based on the determined number of the rows of the data in the subset comprises:
determining the price to charge the user to access the result based on the determined number of the rows of the data in the subset, the first price, and the second price.

6. The method of claim 1, further comprising:
receiving an indicator that specifies a number of the rows of the data that are included in a second subset of the data that is analyzed with respect to execution of the query;
wherein the second subset includes more of the data that is stored in the store than the first subset; and
wherein determining the price to charge the user to access the result based on the determined number of the rows of the data in the subset comprises:
determining the price to charge the user to access the result based on the determined number of the rows of the data in the first subset and the number of the rows of the data that are included in the second subset.

7. The method of claim 1, further comprising:
providing a price indicator to the user that specifies the price to charge the user to access the result.

8. The method of claim 1, wherein executing the query against the store comprises:
executing a stored procedure against the store; and
wherein receiving the result based on the query comprises:
receiving the result based on the stored procedure.

9. A method of pricing access to data in a networked environment, comprising:
requesting a non-inline query plan regarding a query from a store;
determining that the query plan includes a function to be executed with respect to the query;
determining a function price of the function; and
determining a price to charge a user who issues the query to access a result that corresponds to the query based on the function price.

10. The method of claim 9, further comprising:
executing the query against the store, which stores data among a plurality of tables, each table including respective rows and columns of the data;
receiving the result based on the query, the result including a subset of the data; and
determining a number of rows of the data in the subset;
wherein determining the price to charge the user to access the result based on the function price comprises:
determining the price to charge the user to access the result based on the function price and the number of the rows of the data in the subset.

11. The method of claim 10, further comprising:
determining a number of columns of the data in the subset;
wherein determining the price to charge the user to access the result based on the function price comprises:
determining the price to charge the user to access the result based on the function price, the number of the rows of the data in the subset, and the number of the columns of the data in the subset.

12. The method of claim 11, further comprising:
determining a base price for the number of the columns of the data in the subset; and
determining a premium price associated with at least one of the columns of the data in the subset that is to be charged in addition to the base price;
wherein determining the price to charge the user to access the result based on the function price comprises:
determining the price to charge the user to access the result based on the function price, the number of the rows of the data in the subset, the number of the columns of the data in the subset, the base price, and the premium price.

13. The method of claim 9, further comprising:
providing a price indicator to the user that specifies the price to charge the user to access the result.

14. The method of claim 9, wherein requesting the non-inline query plan regarding the query comprises:
requesting the non-inline query plan regarding a stored procedure; and
wherein determining that the query plan includes the function to be executed with respect to the query comprises:
determining that the query plan includes the function to be executed with respect to the stored procedure.

15. A data access price calculator, comprising:
a query execution module configured to execute a query against a store that stores data among a plurality of tables, each table including respective rows and columns of the data;
a result row determination module configured to determine a number of rows of the data in a result that is received in response to execution of the query, the result including a subset of the data;
a result column determination module configured to determine a number of columns of the data in the result; and
an access price determination module configured to determine a price to charge a user who issues the query to access the result based on the number of the rows and the number of the columns of the data in the result.

16. The data access price calculator of claim 15, further comprising:
a base price determination module configured to determine a base price for the number of the columns of the data in the result; and
a premium price determination module configured to determine a premium price associated with at least one of the columns of the data in the result that is to be charged in addition to the base price;
wherein the price to charge the user to access the result takes into consideration the base price and the premium price.

17. The data access price calculator of claim 15, further comprising:
a contribution row determination module configured to determine a number of rows of the data that are included in a second subset of the data that is analyzed with respect to execution of the query based on an indicator received from the store;
wherein the second subset includes more of the data that is stored in the store than the first subset; and
wherein the price to charge the user to access the result is further based on the number of the rows of the data that are included in the second subset.

18. The data access price calculator of claim 17, further comprising:
a contribution column determination module configured to determine a number of columns of the data that are included in the second subset;
wherein the price to charge the user to access the result is further based on the number of the columns of the data that are included in the second subset.

19. The data access price calculator of claim 15, further comprising:
a query plan request module configured to request a non-inline query plan regarding the query from the store;
a function determination module configured to determine that the query plan includes a function to be executed with respect to the query; and
a function price determination module configured to determine a function price of the function;
wherein the price to charge the user to access the result is further based on the function price.

20. The data access price calculator of claim 15, further comprising:
a price indication module configured to provide a price indicator to the user that specifies the price to charge the user to access the result.
